(19) United States
(12) Patent Application Publication
(10) Pub. No.: US 2005/0103176 A1
(43) Pub. Date: May 19, 2005

(54) Sawing direction positioning system for a woodworking bandsaw

(76) Inventors: Ross Zhang, Shandong Province (CN); Faqi Huai, Shandong Province (CN); Shuai Yin, Shandong Province (CN)

Correspondence Address: RATNERPRESTIA, P O BOX 980, VALLEY FORGE, PA, 19482-0980, US

(21) Appl. No.: 10/951,086

(22) Filed: Sep. 27, 2004

(30) Foreign Application Priority Data
Oct. 10, 2003 (CN) 200320106123.0
Nov. 27, 2003 (CN) 200320121027.3
Oct. 10, 2003 (CN) 200320106024.2
Dec. 15, 2003 (CN) 200320121345.X
Nov. 27, 2003 (CN) 200320121028.8
Mar. 2, 2004 (CN) 200420038889.4

(51) Int. Cl. B26D 7/00

(52) U.S. Cl. 83/520

(57) ABSTRACT

The present invention relates to a sawing direction positioning system for a woodworking bandsaw. The system includes a light-emitting unit for emiting a planar light beam, the light-emitting unit being has a power supply via a lead and positioned above the woodworking bandsaw so that the planar light beam emitted from the light-emitting unit coincides exactly with the plane of the saw blade mounted on the woodworking bandsaw. During sawing, the projection line of the planar light beam always projects on the wood to be sawed and is not obstructed by sawdust. The operator has a good visual field and pushes the wood to be sawed along a right straight line drawn on the wood making sure that the sawing direction is correct or keeps in line with the drawn straight line thereby preventing the kerf from offsetting and reducing thus reducing rejected products.

### FIELD OF THE INVENTION

The present invention relates to a positioning system, and more particularly, to a sawing direction positioning system for a woodworking bandsaw.

### DESCRIPTION OF THE BACKGROUND ART

A woodworking bandsaw is a woodworking machine that saws linearly a wood. When a conventional woodworking bandsaw is used to saw a wood, a guide plate is preset appropriately on the woodworking bandsaw and the wood to be sawed is then pushed forwardly against the guide plate during working. In other way, a straight line is drawn on the wood to be sawed beforehand and the wood to be sawed is then pushed forwardly along the straight line during working. During sawing, one operator should keep his eyes on the position of the wood to ensure that the sawing direction is correct or keeps in line with the drawn straight line, thereby preventing the kerf from offsetting. However, other things such as sawdust may obstruct the operator's sight line so that it is difficult for the operator to control the sawing, thereby resulting in many rejected products.

### SUMMARY OF THE INVENTION

An object of the invention is to overcome the defects and problems in the prior art and provide a sawing direction positioning system for a woodworking bandsaw.

To achieve the object of the invention, there is provided a sawing direction positioning system for a woodworking bandsaw comprising a light-emitting unit for emitting a planar light beam, said light-emitting unit being connected with a power supply via a lead and positioned above said woodworking bandsaw so that said planar light beam emitted from the light-emitting unit coincides exactly with the plane of a saw blade mounted on said woodworking bandsaw.

The sawing direction positioning system for a woodworking bandsaw according to the present invention is simple and low-cost. During sawing, adjustment may be made easily so that the wood to be sawed is positioned rapidly and accurately along a correct sawing direction. It can be used widely in various woodworking bandsaws to saw the wood whose surface is ragged and difficult to draw a line thereon.

### BRIEF DESCRIPTION OF THE DRAWINGS

FIG. 1 is a schematic view showing a woodworking bandsaw provided with a sawing direction positioning system according to the present invention.

FIG. 2 is a schematic view showing the installation of the sawing direction positioning system according to the present invention.

FIG. 3 is a schematic diagram showing the light-emitting unit according to the present invention.

### DETAILED DESCRIPTION OF THE PREFERRED EMBODIMENTS

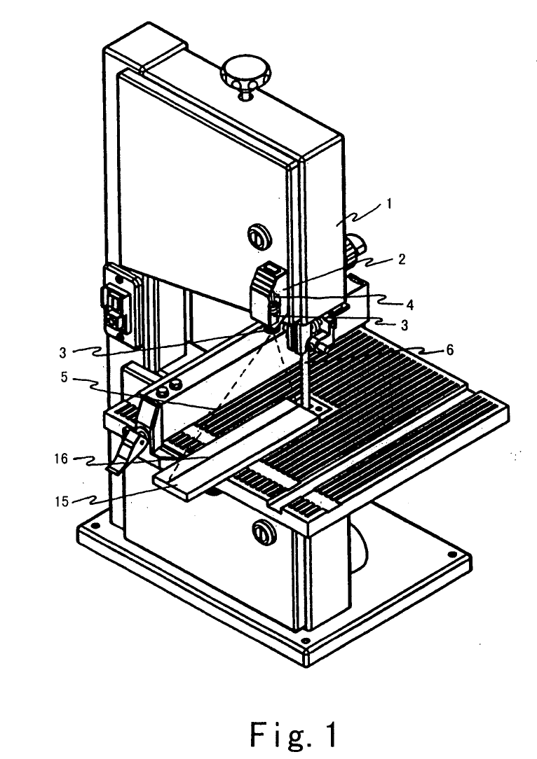

As shown in FIG. 1, a sawing direction positioning system for a woodworking bandsaw according to the present invention includes one light-emitting unit 3 for emitting a planar light beam 5. The light-emitting unit 3 is positioned above the woodworking bandsaw so that the planar light beam 5 emitted from the light-emitting unit 3 coincides exactly with the plane of a saw blade 6 mounted on the woodworking bandsaw. Preferably, the light-emitting unit 3 is positioned at a fixing seat 2 provided on an upper box 1 of the woodworking bandsaw. The light-emitting unit 3 is connected with a power supply via a lead 4. The projection line of the planar light beam 5 on a wood 15 to be sawed, i.e. the intersecting line of the planar light beam 5 and the wood 15 is a very fine straight line 16.

Preferably, the light-emitting unit 3 for emitting the planar light beam 5 is pen-shaped.

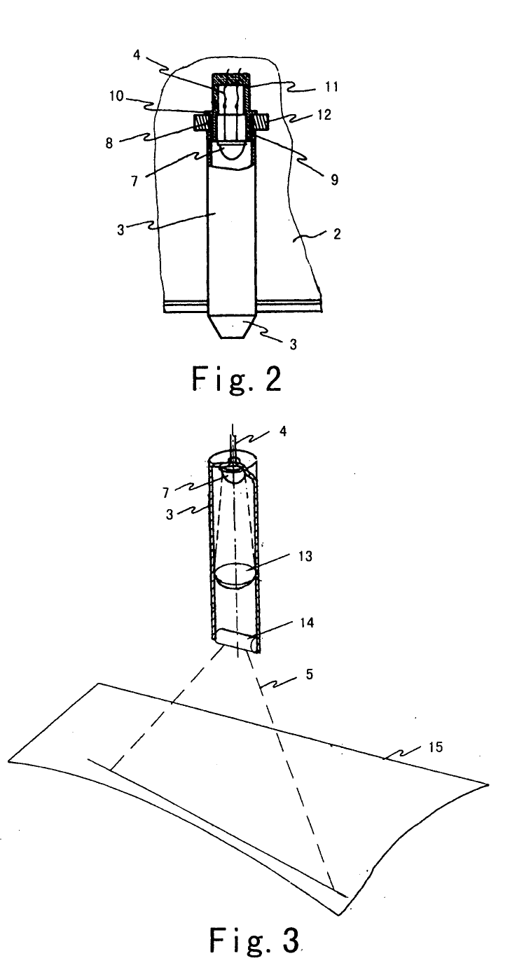

As shown in FIG. 2, a hole 8 for receiving the light-emitting unit 3 is formed on the fixing seat 2. The light-emitting unit 3 is installed in the hole 8 of the fixing seat 2. At the top end of the light-emitting unit 3 opposite to the emitting end are formed female or male threads 9. A regulatory screw 11 with corresponding male or female threads and a shoulder 10 engages with the female or male threads 9. The regulatory screw 11 and the light-emitting unit 3 are clamped on a shoulder 12 provided at the fixing seat 2 by means of the threads. By loosening the regulatory screw 11, the position of the light-emitting unit 3 may be adjusted circumferentially, thus adjusting the direction and position of the planar light beam 5. Of course, adjusting the fixing seat 2 relative to the upper box 1 of the woodworking bandsaw also changes the direction and position of the planar light beam 5.

FIG. 3 shows the light-emitting unit 3 according to the present invention in detail. In the present preferred embodiment, the light-emitting unit 3 according to the present invention includes a light source 7, a converging lens 13 disposed coaxially in front of the light source 7 and a cylindrical lens 14 disposed coaxially in front of the converging lens 13. The light emitted from the light source 7 is converged by the converging lens 13 and then passes through the cylindrical lens 14 to form the planar light beam 5. Of course, a corrugated lens may be used instead of the cylindrical lens.

A laser diode may be used as the light source 7. Usually, the laser diode is of high power and emits bright light that may injure the operator's eyes. Further, the laser diode generally emits only red light so that it is difficult to meet the requirements for colours in different applications.

Preferably, a light emitting diode is used as the light source 7. The light emitting diode may emit lights of various colours that do not injure the operator's eyes. For example, the light emitting diode may emit lights such as white, blue, red, green and yellow to meet the requirements in different applications. Compared with a laser diode, a light emitting diode is more cost-effective. The light emitting diode 7 maybe a monochromatic light emitting diode, a two-color light emitting diode or a RGB light emitting diode. If a two-color light emitting diode or a RGB light emitting diode is used, they may also emit a monochromatic light as required by means of a control circuit.

As shown in FIGS. 1 and 2, at mounting a sawing direction positioning system for a woodworking bandsaw according to the present invention, the center lines of the fixing seat 2 and the light-emitting unit 3 coincide exactly with the plane of the saw blade 6 by adjusting the fixing seat 2 relative to the upper box 1 of the woodworking bandsaw. When the light-emitting unit 3 is switched on, the planar light beam 5 emitted from the light-emitting unit 3 projects a very fine straight line 16 on the wood 15 to be sawed. The wood 15 at two ends of the portion to be sawed was marked with two dots or drawn with a line. During sawing, by manually adjusting the wood 15, the projection line 16 always passes through the marked dots or keeps alignment with the drawn line on the wood, and the saw blade 6 always saws the wood 15 along the projection line 16. Thus, a desirable kerf is worked. To ensure that the projection line 16 is clear and visible, it is possible to choose an appropriate light such as white, blue and red that considerably contrasts with the wood to be sawed.

By loosening the regulatory screw 11, the light-emitting unit 3 may rotate on the fixing seat until the projection line 16 of the planar light beam emitted from the light-emitting unit 3 coincides precisely with the plane of the saw blade 6. The light-emitting unit 3 is then kept in position by hand while the regulatory screw 11 is tightened.

During sawing, the projection line 16 of the planar light beam emitted from the light-emitting unit 3 always projects on the wood to be sawed and is not obstructed by the sawdust at all. The operator may have a good visual field and push the wood to be sawed forwardly along the right straight line to ensure that the sawing direction is correct or keeps in line with the drawn straight line, thereby preventing the kerf from offsetting and reducing the rejected products.

Having described the invention in detail, those skilled in the art will appreciate that modifications of this invention may be made without departing from its spirit. Therefore, it is not intended to limit the present invention only to the preferred embodiments illustrated and described. Rather, the scope of the invention is to be determined by the appended claims and their equivalents.

This application incorporates by reference the patent applications titled:

“SAWING DIRECTION POSITIONING SYSTEM FOR A BENCH SAW” to Ross Zhang filed concurrently herewith; and

“SAWING DIRECTION POSITIONING SYSTEM FOR A JIGSAW” to Ross Zhang filed concurrently herewith.

1. A sawing direction positioning system for a woodworking bandsaw comprising a light-emitting unit for emitting a planar light beam, said light-emitting unit being connected with a power supply via a lead and positioned above said woodworking bandsaw so that said planar light beam emitted from the light-emitting unit coincides exactly with the plane of a saw blade mounted on said woodworking bandsaw.

2. A sawing direction positioning system as claimed in claim 1, wherein said light-emitting unit is positioned at a fixing seat provided on an upper box of the woodworking bandsaw.

3. A sawing direction positioning system as claimed in claim 1, wherein a projection line of the planar light beam on a wood to be sawed is a very fine straight line.

4. A sawing direction positioning system as claimed in claim 1, wherein said light-emitting unit for emitting the planar light beam is pen-shaped.

5. A sawing direction positioning system as claimed in claim 1, wherein a hole for receiving said light-emitting unit is formed on said fixing seat, at the top end of the light-emitting unit opposite to the emitting end are formed female or male threads for engaging with a regulatory screw with corresponding male or female threads and a shoulder, and said regulatory screw and said light-emitting unit are clamped on said fixing seat by means of said threads.

6. A sawing direction positioning system as claimed in claim 5, wherein the light-emitting unit rotates on the fixing seat by loosening the regulatory screw to change the direction and position of said planar light beam.

7. A sawing direction positioning system as claimed in claim 2, wherein said fixing seat is adjusted relative to said upper box of said woodworking bandsaw to change the direction and position of said planar light beam.

8. A sawing direction positioning system as claimed in claim 1, wherein said light-emitting unit includes a light source, a converging lens disposed coaxially in front of said light source and a cylindrical lens disposed coaxially in front of said converging lens.

9. A sawing direction positioning system as claimed in claim 1, wherein said light-emitting unit includes a light source, a converging lens disposed coaxially in front of said light source and a corrugated lens disposed coaxially in front of said converging lens.

10. A sawing direction positioning system as claimed in claim 8, wherein said light source is a laser diode.

11. A sawing direction positioning system as claimed in claim 8, wherein said light source is a light emitting diode.

12. A sawing direction positioning system as claimed in claim 11, wherein said light emitting diode emits light of different colours to meet the requirements in different applications.

13. A sawing direction positioning system as claimed in claim 9, wherein said light source is a laser diode.

14. A sawing direction positioning system as claimed in claim 9, wherein said light source is a light emitting diode.

15. A sawing direction positioning system as claimed in claim 14, wherein said light emitting diode emits light of different colours to meet the requirements in different applications.
